(19) United States
(12) Patent Application Publication
(10) Pub. No.: US 2023/0181297 A1
(43) Pub. Date: Jun. 15, 2023

(54) ELASTIC DENTAL FLOSS LOOP

(71) Applicant: Christopher Thomas-Jay Sizemore, Nashville, TN (US)

(72) Inventor: Christopher Thomas-Jay Sizemore, Nashville, TN (US)

(21) Appl. No.: 17/644,374

(22) Filed: Dec. 15, 2021

(51) Int. Cl. A61C 15/04

(52) U.S. Cl. CPC A61C 15/042

(57) ABSTRACT

A dental floss loop includes an elastic band having a diameter when in a relaxed position smaller than a distance between a user's thumb and pinkie on one hand.

### BACKGROUND OF THE INVENTION

The present invention relates to dental floss and, more particularly, to an elastic dental floss loop.

Currently available dental floss does not work on all teeth gaps, is not reusable, cannot be used one-handed, and hurts the user's fingers during use.

As can be seen, there is a need for a reusable dental floss that fits all teeth gaps and may be used one-handed without hurting the user's fingers.

### SUMMARY OF THE INVENTION

In one aspect of the present invention, a dental floss loop is provided comprising an elastic band having a diameter, in a relaxed position, smaller than a distance between a user's thumb and a finger distal thereto on one hand.

These and other features, aspects and advantages of the present invention will become better understood with reference to the following drawings, description, and claims.

### BRIEF DESCRIPTION OF THE DRAWINGS

FIG. 1 is a perspective view of a dental floss band according to an embodiment of the present invention, shown in use;

FIG. 2 is a perspective view thereof, shown with ribs;

FIG. 3 is a perspective view thereof, shown in-use with a portion stretched;

FIG. 4 is a top plan view thereof, shown stretched;

FIG. 5 is an enlarged detail view thereof, shown stretched;

FIG. 6 is a perspective view thereof, shown with stubs;

FIG. 7 is a perspective view thereof, shown with abrasive texture;

FIG. 8 is a perspective view thereof, shown with ribs and stubs; and

FIG. 9 is a perspective view thereof, shown with ribs, stubs, and abrasive texture.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “mildly abrasive” refers to a relative dentin abrasivity greater than zero to about 150.

Broadly, one embodiment of the present invention is an elastic dental floss loop.

The inventive elastic dental floss loop may be an elastic band, such as a thick ridged surgical rubber band, that gets thinner and narrower the more you stretch it so that it fits different size gaps of teeth. It fits between or encircles two fingers and may be used one handed. For example, the loop when in a relaxed position may have a diameter smaller than a distance between a user's thumb and a finger distal thereto on one hand or a circumference smaller than the width of the user's hand.

The inventive floss loop may be reusable. The loop may alternatively be used as a hair tie and/or a money holder

In some embodiments, the elastic dental floss loop may be ribbed or ridged. The types of ribs may vary.

In some embodiments, the elastic dental floss loop may have a plurality of abrasion protrusions or stubs. For example, at least one surface of the loop or elastic band may be characterized by a plurality of abrasion protrusions.

In some embodiments, the elastic dental floss loop may be mildly abrasively textured.

In some embodiments, at least one surface of the elastic band may be characterized by a plurality of abrasion protrusions selected from the group consisting of ribs, stubs, abrasive texturing, and any combination thereof.

The materials of manufacture are not particularly limited. The loop may be manufactured of surgical rubber, for example. The abrasive texture; protrusions or stubs; and/or ribs or ridges may be formed from the surgical rubber or may be made from a mildly abrasive substance adhered to the surgical rubber.

To use the elastic dental floss loop, place the floss between two fingers, stretch to a suitable width, insert into a gap between the user's teeth, and slide back and forth. The elastic dental floss loop may remove anything stuck between the teeth.

In some embodiments, the elastic dental floss loop may have a waxed surface.

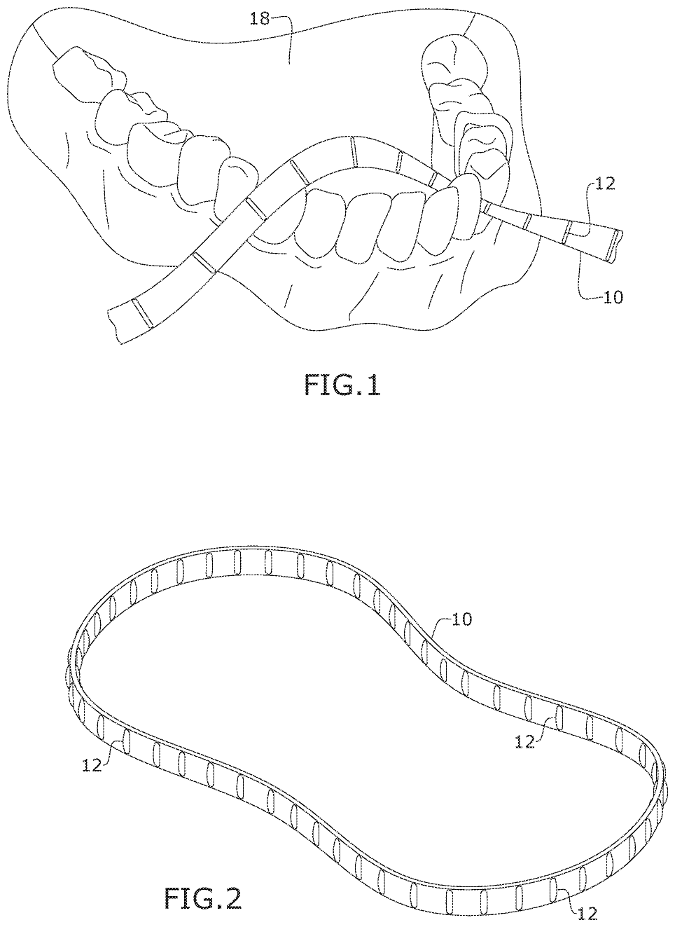

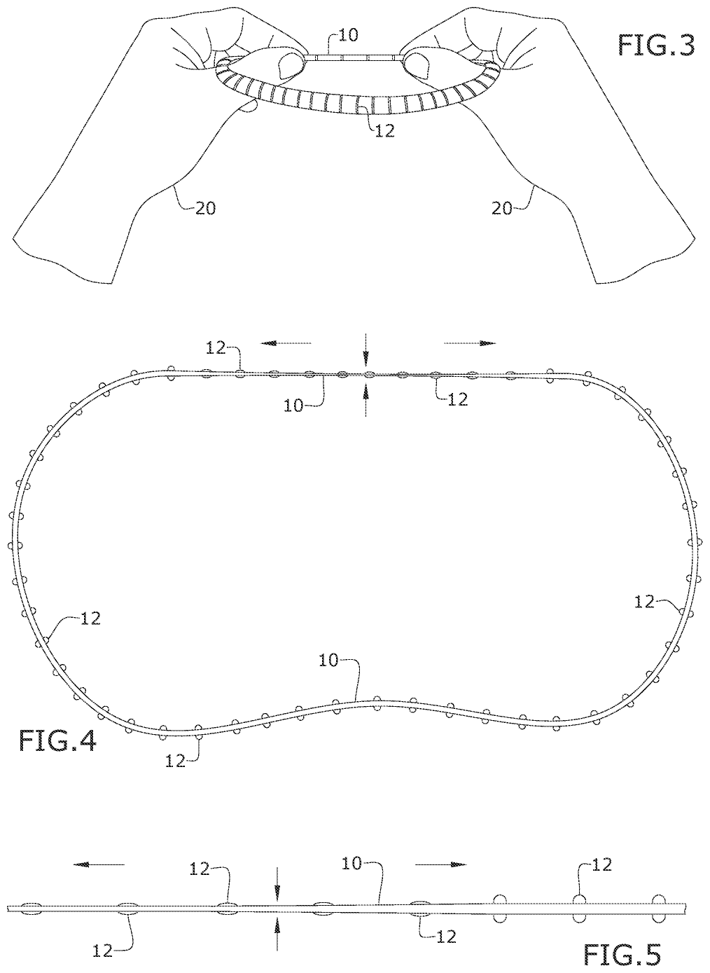

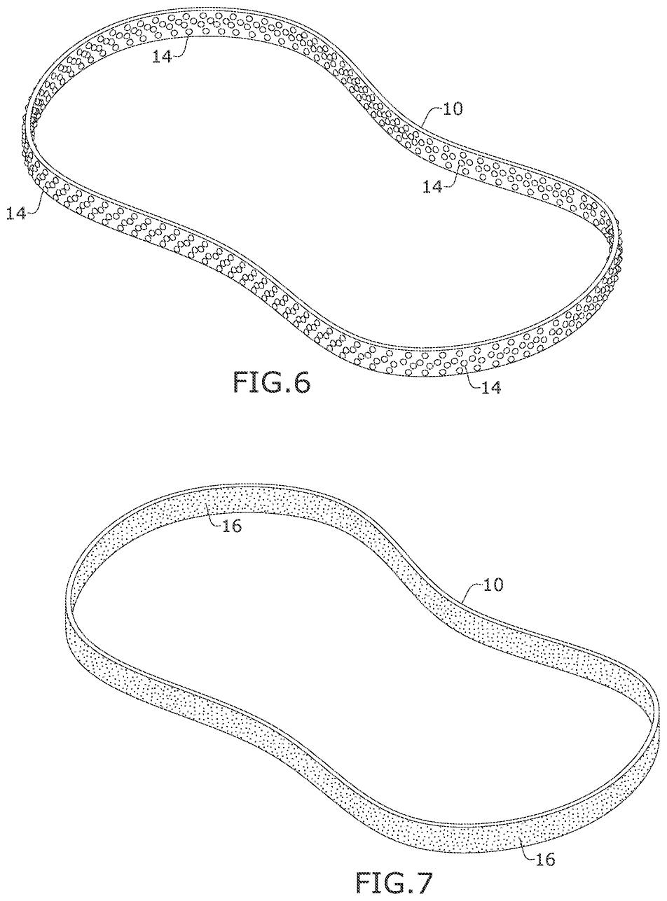

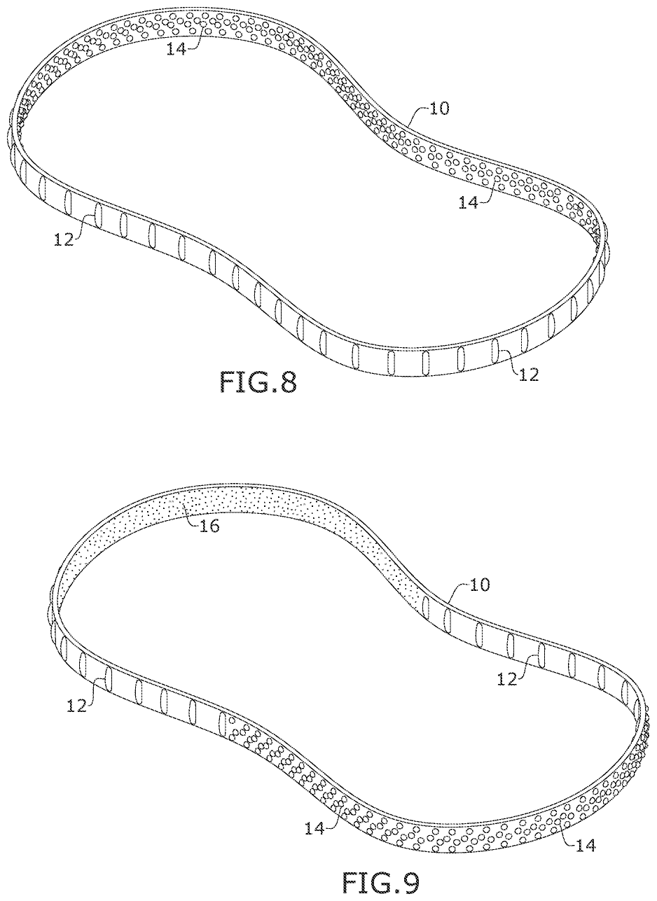

Referring to FIGS. 1 through 9, FIG. 1 shows a surgical rubber band 10 with ribs 12 according to an embodiment of the present invention inserted into a tooth gap in a user's mouth 18. The ribs 12 are more clearly shown in FIGS. 2, 4, and 5. As shown in FIG. 3, the surgical rubber band 10 may be stretched between the user's hands 20 to narrow a portion of the band 10. FIGS. 6 through 9 show alternative embodiments having stubs 14, mildly abrasive texture 16, and combinations of ribs 12, stubs 14, and/or mildly abrasive texture 16.

It should be understood, of course, that the foregoing relates to exemplary embodiments of the invention and that modifications may be made without departing from the spirit and scope of the invention as set forth in the following claims.

What is claimed is:

1. A dental floss loop comprising a mildly abrasive elastic band having a diameter, in a relaxed position, smaller than a distance between a user's thumb and a finger distal thereto on one hand.

2. The dental floss loop of claim 1, wherein the elastic band comprises surgical rubber.

3. The dental floss loop of claim 1, wherein at least one surface of the elastic band is characterized by a plurality of abrasion protrusions selected from the group consisting of ribs, stubs, abrasive texturing, and any combination thereof.

4. The dental floss loop of claim 1, wherein at least one surface of the elastic band has a relative dentin abrasivity of greater than zero to about 150.
